(19) United States
(12) Patent Application Publication
(10) Pub. No.: US 2010/0148908 A1
(43) Pub. Date: Jun. 17, 2010

(54) TRANSFORMER

(75) Inventors: C. S. Kung, Taoyuan Hsien (TW); H. X. Wu, Dong-Guan City (CN); Chang-Bing Fang, Dong-Guan City (CN)

Correspondence Address: GROSSMAN, TUCKER, PERREAULT & PFLEGER, PLLC, 55 SOUTH COMMERICAL STREET, MANCHESTER, NH, 03101, US

(73) Assignee: DELTA ELECTRONICS, INC., Taoyuan Hsien (TW)

(21) Appl. No.: 12/389,917

(22) Filed: Feb. 20, 2009

(30) Foreign Application Priority Data
Dec. 15, 2008 (TW) 097222482

(51) Int. Cl. H01F 27/29

(52) U.S. Cl. 336/192

(57) ABSTRACT

A transformer which comprises a winding frame, at least one primary coil assembly, and at least one feedback coil assembly is provided. The winding frame has at least one primary winding area and at least one feedback winding area. The at least one primary coil assembly which is wound around the at least one primary winding area and electrically connected to a microcontroller is configured to receive an input voltage. The at least one feedback coil assembly which is wound around the at least one feedback winding area and electrically connected to the microcontroller is configured to output an induced voltage to the microcontroller. The microcontroller is configured to adjust the input voltage received by the at least one primary coil assembly according to the induced voltage.

This application claims the benefit of priority based on Taiwan Patent Application No. 097222482, filed on Dec. 15, 2008, the contents of which is incorporated herein by reference in its entirety.

### CROSS-REFERENCES TO RELATED APPLICATIONS

Not applicable.

### BACKGROUND OF THE INVENTION

1. Field of the Invention

The present invention relates to a transformer. More particularly, the present invention relates to a transformer for adjusting an input voltage via a microcontroller.

2. Descriptions of the Related Art

FIG. 1 depicts a conventional transformer 1, which comprises a winding frame 11 and a core assembly comprising a U-shaped core 15a and an I-shaped core 15b. The winding frame comprises a primary winding area 111, a secondary winding area 113, two disposed areas 171, a separating portion 115 and a jack 117. The two disposed areas 171 are disposed on two opposite ends of the winding frame 11. There is a separating portion 115 between the primary winding area 111 and the secondary winding area 113. The primary winding area 111 has a primary coil assembly (not shown) wound thereon, while the secondary winding area 113 has a secondary coil assembly (not shown) wound thereon. The winding frame 11 has two first conductive terminals 131a, 131b and two second conductive terminals 133a, 133b. The first conductive terminals 131a, 131b are adapted to electrically connect to the primary coil, while the second conductive terminals 133a, 133b are adapted to electrically connect to the secondary coil. The I-shaped core 15b is inserted through the jack 117 of the winding frame 11, while the U-shaped core 15a is disposed in the two disposed areas 171 and abuts against the I-shaped core 15b. The U-shaped core 15a and the I-shaped core 15b that form the core assembly are made of a Mn—Zn alloy material.

The transformer 1 has a rated input voltage, so that when an input voltage is inputted to the primary coil assembly wound on the primary winding area 111 via the first conductive terminals 131a, 131b, an output voltage will be outputted via the second conductive terminals 133a, 133b by the secondary coil assembly wound on the secondary winding area 113. If the input voltage exceeds the rated input voltage of the transformer 1, the transformer would be burnt out, thereby causing damage to the electronic product where the transformer 1 is installed. Furthermore, the core assembly of the conventional transformer 1 is completely made of a Mn—Zn alloy material. Because the Mn—Zn alloy per se is conductive, a clearance needs to be kept between the core assembly (i.e., the U-shaped core 15a and the I-shaped core 15b) and the winding frame 11 to maintain a fixed safety distance. As a result, adding the clearance significantly increases the volume of the conventional transformer 1.

In view of this, it is important to not only break the limitation on the characteristics of the conventional transformer 1 to prevent the transformer from being burnt out when the input voltage exceeds the rated input voltage thereof, but also to miniaturize the transformer by reducing the clearance between the core assembly and the winding frame.

### SUMMARY OF THE INVENTION

The primary objective of this invention is to provide a transformer for adjusting an input voltage via a microcontroller, which comprises a winding frame, at least one primary coil assembly, at least one secondary coil assembly, at least one feedback coil assembly, and a core assembly. The winding frame comprises at least one primary winding area, at least one secondary winding area and at least one feedback winding area. The at least one primary coil assembly is wound around the at least one primary winding area, the at least one secondary coil assembly is wound around the at least one secondary winding area, and the at least one feedback coil assembly is wound around the at least one feedback winding area. The at least one primary coil assembly is configured to receive the input voltage. The at least one feedback coil assembly is configured to output an induced voltage to the microcontroller so that the microcontroller adjusts the input voltage received by the at least one primary coil assembly according to the induced voltage.

The core assembly comprises a U-shaped core and an I-shaped core, one of which is made of a nonconductive material. The nonconductive material may be a Ni—Zn alloy, a Mg—Zn alloy, or a combination thereof. In more detail, if the U-shaped core is made of a nonconductive material, the I-shaped core may be made of a Mn—Zn alloy, a nonconductive material, or a combination thereof. Conversely, if the I-shaped core is made of a nonconductive material, the U-shaped core may be made of a Mn—Zn alloy, a nonconductive material, or a combination thereof. Because either the U-shaped core or the I-shaped core is nonconductive, it is unnecessary to maintain a fixed safety distance in the transformer of this invention, which allows the transformer of this invention to be miniaturized.

The transformer of this invention regulates the magnitude of the input voltage by providing the additional feedback winding area on the winding frame to prevent the transformer from being burnt out when the input voltage exceeds a rated input voltage. Meanwhile, because the core assembly of the transformer of this invention is made of a nonconductive material, the fixed safety distance is further minimized, thereby resulting in a miniaturized transformer.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a conventional transformer;

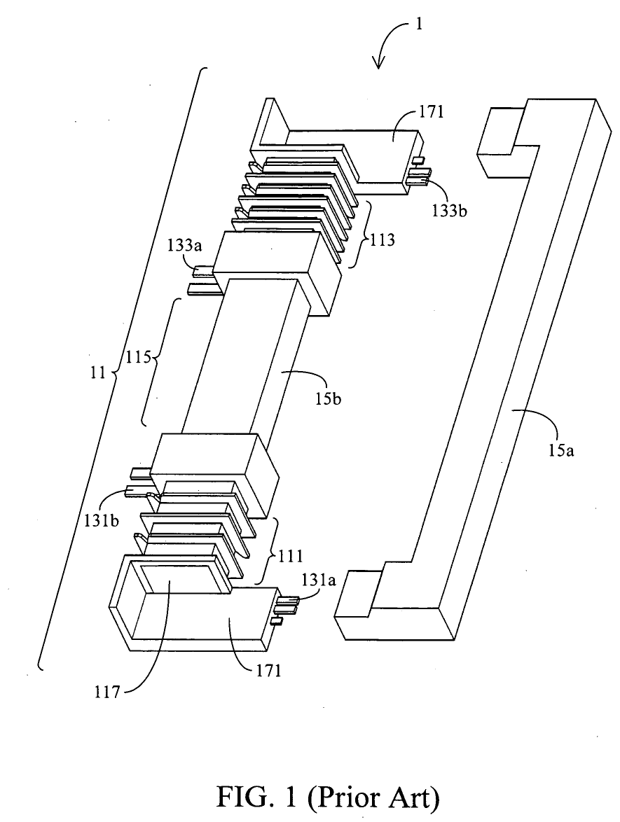

FIG. 2 is a schematic view of the preferred embodiment of the present invention; and

FIG. 3 is another schematic view of the preferred embodiment of the present invention.

### DESCRIPTION OF THE PREFERRED EMBODIMENT

In the following description, this invention will be explained with reference to embodiments thereof. However, these embodiments are not intended to limit this invention to any specific environment, applications or implementations described in these embodiments. Therefore, description of these embodiments is only for purposes of illustration rather than to limit the present invention. It should be appreciated that in the following embodiments and the attached drawings, elements unrelated to this invention are omitted from depiction.

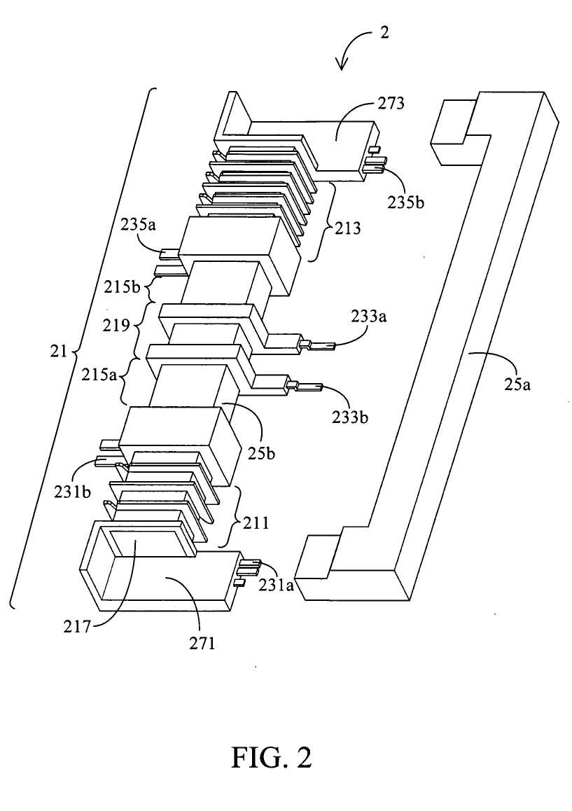

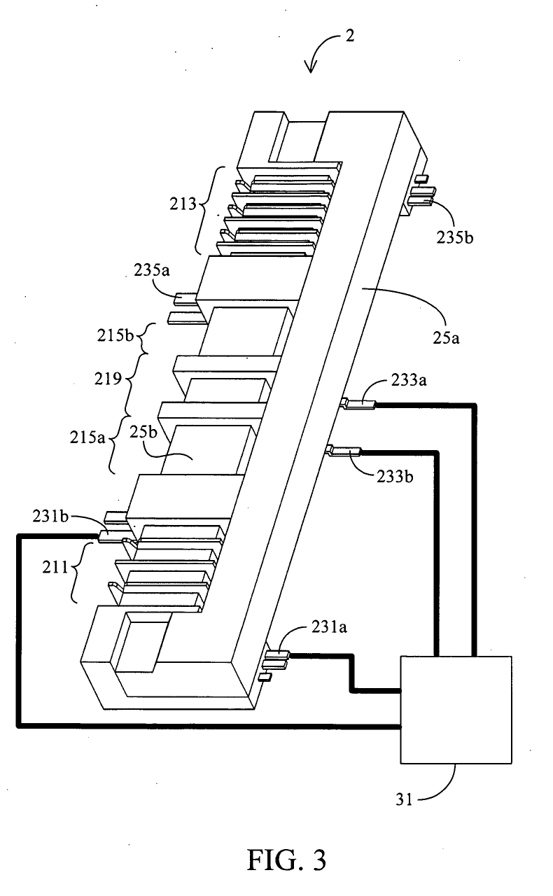

FIGS. 2 and 3 are schematic views of a transformer 2 according to a preferred embodiment of this invention. The transformer 2 comprises a winding frame 21 and a core assembly comprising a first core 25a and a second core 25b. The winding frame comprises at least one primary winding area 211, at least one secondary winding area 213, at least one feedback winding area 219 and at least two disposed areas 271, 273. The feedback winding area 219 is disposed on a first side of the primary winding area 211 and a first side of the secondary winding area 213. The disposed areas 271, 273 are respectively located on two opposite sides of the winding frame 21; i.e., the disposed area 271 is located on the second side of the primary winding area 211 while the disposed area 273 is located on a second side of the secondary winding area 213. The transformer 2 further comprises at least one primary coil assembly (not shown) wound around the primary winding area 211, at least one secondary coil assembly (not shown) wound around the secondary winding area 213, and at least one feedback coil assembly (not shown) wound around the feedback winding area 219.

The first core 25a of the core assembly is a U-shaped core having extension portions that mate with the at least two disposed areas 271, 273 of the winding frame 21. The second core 25b of the core assembly is an I-shaped core inserted into a jack 217 of the winding frame 21. As depicted in FIG. 3, after the first core 25a (the U-shaped core), the second core 25b (the I-shaped core) and the winding frame 21 are assembled together, both sides of the second core 25b will abut against the extension portions of the first core 25a.

Either the first core 25a or the second core 25b is made of a nonconductive material, for example, a Ni—Zn alloy, a Mg—Zn alloy, or a combination thereof. In more detail, if the first core 25a is made of a nonconductive material, the second core 25b may be made of a Mn—Zn alloy, a nonconductive material, or a combination thereof. Conversely, if the second core 25b is made of a nonconductive material, the first core 25a may be made of a Mn—Zn alloy, a nonconductive material, or a combination thereof. Because either the first core 25a or the second core 25b is nonconductive, it is unnecessary to maintain a fixed safety distance between the winding frame 21 and the core assembly of the transformer 2.

There is a first separating portion 215a between the primary coil assembly and the feedback coil assembly. In addition, there is a second separating portion 215b between the secondary coil assembly and the feedback coil assembly. The primary coil assembly is electrically connected to a microcontroller 31 via two first conductive terminals 231a, 231b to receive an input voltage from the microcontroller 31. The feedback coil assembly is electrically connected to the microcontroller 31 via two second conductive terminals 233a, 233b to output an induced voltage to the microcontroller 31. The secondary coil assembly is configured to output an output voltage via two third conductive terminals 235a, 235b. After receiving the induced voltage outputted via the second conductive terminals 233a, 233b by the feedback coil assembly, the microcontroller 31 adjusts the input voltage received as described above according to the induced voltage.

According to the above description, the transformer of this invention transmits an induced voltage to the microcontroller via the feedback coil assembly located between the primary coil assembly and the secondary coil assembly so that the microcontroller may adjust the input voltage received by the primary coil assembly according to the induced voltage. As a result, the transformer does not be burnt out when the input voltage exceeds the rated input voltage thereof. Furthermore, because the core assembly is made of a nonconductive material, the transformer of this invention can be miniaturized.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A transformer for adjusting an input voltage via a microcontroller, comprising:
a winding frame having a jack, at least one primary winding area, at least one secondary winding area, at least one feedback winding area, and at least two disposed areas, wherein the at least one feedback winding area is placed on a first side of the at least one primary winding area and a first side of the at least one secondary winding area, the at least two disposed areas are respectively placed on a second side of the at least one primary winding area and a second side of the at least one secondary winding area;
at least one primary coil assembly, wound around the at least one primary winding area and electrically connected to the microcontroller via at least one first conductive terminal, being configured to receive the input voltage;
at least one secondary coil assembly being wound around the at least one secondary winding area; and
at least one feedback coil assembly, wound around the at least one feedback winding area and electrically connected to the microcontroller via at least one second conductive terminal, being configured to output an induced voltage to the microcontroller via the at least one second conductive terminal so that the microcontroller adjusts the input voltage received by the at least one primary coil assembly according to the induced voltage.

2. The transformer as claimed in claim 1, wherein the at least on secondary coil assembly outputs an output voltage via at least one third conductive terminal.

3. The transformer as claimed in claim 1, wherein there is a first separating portion between the at least one feedback coil assembly and the at least one primary coil assembly, and there is a second separating portion between the at least one feedback coil assembly and the at least one secondary coil assembly.

4. The transformer as claimed in claim 3, wherein the jack of the winding frame is through the first separating portion and the second separating portion.

5. The transformer as claimed in claim 1, further comprising:
a first core having at least two extension portions, wherein the at least two extension portions are respectively fitted the at least two disposed areas of the winding frame; and
a second core, being an I-shaped core, being inserted into the jack of the winding frame and abutting against the extension portions of the first core.

6. The transformer as claimed in claim 5, wherein one of the first core and the second core is made of nonconductive material.

7. The transformer as claimed in claim 6, wherein the first core is made of one of a Ni—Zn alloy, a Mn—Zn alloy, a Mg—Zn alloy, and a combination thereof.

8. The transformer as claimed in claim 6, wherein the second core is made of one of a Ni—Zn alloy, a Mn—Zn alloy, a Mg—Zn alloy, and a combination thereof.
